(19) United States
(12) Patent Application Publication
(10) Pub. No.: US 2026/0333312 A1
(43) Pub. Date: Oct. 22, 2026

(54) MIMO CODE BLOCK-TO-LAYER MAPPING

(71) Applicant: QUALCOMM Incorporated, San Diego, CA (US)

(72) Inventors: Kirill IVANOV, La Jolla, CA (US); Wei YANG, San Diego, CA (US); Jae Ho RYU, San Diego, CA (US); Jing JIANG, San Diego, CA (US)

(21) Appl. No.: 19/184,647

(22) Filed: Apr. 21, 2025

(51) Int. Cl. H04W 72/0446; H04B 7/0413

(52) U.S. Cl. CPC H04W 72/0446; H04B 7/0413

(57) ABSTRACT

Various aspects of the present disclosure generally relate to wireless communication. In some aspects, a user equipment (UE) may transmit, in accordance with a multiple-input multiple-output (MIMO) configuration, a first transport block segmented into a first set of code blocks (CBs), wherein each CB in the first set of CBs is divided into two or more segments, the two or more segments including at least a first segment mapped to a first layer or layer group in a first time-frequency resource and a second segment mapped to a second layer or layer group in a second time-frequency resource in accordance with the MIMO configuration. The UE may receive a second set of CBs associated with a second transport block encoded in accordance with the MIMO configuration. Numerous other aspects are described.

### FIELD OF THE DISCLOSURE

Aspects of the present disclosure generally relate to wireless communication and specifically relate to techniques, apparatuses, and methods associated with multiple-input multiple-output code block-to-layer mapping.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

Multiple-input multiple-output (MIMO) refers to a wireless communication technique involving the use of multiple antennas at both the transmitter and receiver sides of a communication link. MIMO enables simultaneous transmission and reception of multiple independent data streams within the same frequency band, which may improve signal quality, increase data throughput, enhance spectral efficiency, and reduce interference.

### SUMMARY

The systems, methods, and devices of this disclosure each have several innovative aspects, no single one of which is solely responsible for the desirable attributes disclosed herein.

Some aspects described herein relate to a user equipment (UE). The UE may include a processing system. The processing system may include one or more processors and one or more code-storing memories coupled with the one or more processors. The processing system may be configured to cause the UE to transmit, in accordance with a multiple-input multiple-output (MIMO) configuration, a first transport block segmented into a first set of code blocks (CBs), where each CB in the first set of CBs is divided into two or more segments, the two or more segments including at least a first segment mapped to a first layer or layer group in a first time-frequency resource and a second segment mapped to a second layer or layer group in a second time-frequency resource in accordance with the MIMO configuration. The processing system may be configured to cause the UE to receive a second set of CBs associated with a second transport block encoded in accordance with the MIMO configuration.

Some aspects described herein relate to a network node. The network node may include a processing system. The processing system may include one or more processors and one or more code-storing memories coupled with the one or more processors. The processing system may be configured to cause the network node to receive, in accordance with a MIMO configuration, a first transport block segmented into a first set of CBs, where each CB in the first set of CBs is divided into two or more segments, the two or more segments including at least a first segment mapped to a first layer or layer group in a first time-frequency resource and a second segment mapped to a second layer or layer group in a second time-frequency resource in accordance with the MIMO configuration. The processing system may be configured to cause the network node to transmit a second set of CBs associated with a second transport block encoded in accordance with the MIMO configuration.

Some aspects described herein relate to a method of wireless communication performed by a UE. The method may include transmitting, in accordance with a MIMO configuration, a first transport block segmented into a first set of CBs, where each CB in the first set of CBs is divided into two or more segments, the two or more segments including at least a first segment mapped to a first layer or layer group in a first time-frequency resource and a second segment mapped to a second layer or layer group in a second time-frequency resource in accordance with the MIMO configuration. The method may include receiving a second set of CBs associated with a second transport block encoded in accordance with the MIMO configuration.

Some aspects described herein relate to a method of wireless communication performed by a network node. The method may include receiving, in accordance with a MIMO configuration, a first transport block segmented into a first set of CBs, where each CB in the first set of CBs is divided into two or more segments, the two or more segments including at least a first segment mapped to a first layer or layer group in a first time-frequency resource and a second segment mapped to a second layer or layer group in a second time-frequency resource in accordance with the MIMO configuration. The method may include transmitting a second set of CBs associated with a second transport block encoded in accordance with the MIMO configuration.

Some aspects described herein relate to a non-transitory computer-readable medium that stores a set of instructions for wireless communication by a UE. The set of instructions, when executed by one or more processors of the UE, may cause the UE to transmit, in accordance with a MIMO configuration, a first transport block segmented into a first set of CBs, where each CB in the first set of CBs is divided into two or more segments, the two or more segments including at least a first segment mapped to a first layer or layer group in a first time-frequency resource and a second segment mapped to a second layer or layer group in a second time-frequency resource in accordance with the MIMO configuration. The set of instructions, when executed by one or more processors of the UE, may cause the UE to receive a second set of CBs associated with a second transport block encoded in accordance with the MIMO configuration.

Some aspects described herein relate to a non-transitory computer-readable medium that stores a set of instructions for wireless communication by a network node. The set of instructions, when executed by one or more processors of the network node, may cause the network node to receive, in accordance with a MIMO configuration, a first transport block segmented into a first set of CBs, where each CB in the first set of CBs is divided into two or more segments, the two or more segments including at least a first segment mapped to a first layer or layer group in a first time-frequency resource and a second segment mapped to a second layer or layer group in a second time-frequency resource in accordance with the MIMO configuration. The set of instructions, when executed by one or more processors of the network node, may cause the network node to transmit a second set of CBs associated with a second transport block encoded in accordance with the MIMO configuration.

Some aspects described herein relate to an apparatus for wireless communication. The apparatus may include means for transmitting, in accordance with a MIMO configuration, a first transport block segmented into a first set of CBs, where each CB in the first set of CBs is divided into two or more segments, the two or more segments including at least a first segment mapped to a first layer or layer group in a first time-frequency resource and a second segment mapped to a second layer or layer group in a second time-frequency resource in accordance with the MIMO configuration. The apparatus may include means for receiving a second set of CBs associated with a second transport block encoded in accordance with the MIMO configuration.

Some aspects described herein relate to an apparatus for wireless communication. The apparatus may include means for receiving, in accordance with a MIMO configuration, a first transport block segmented into a first set of CBs, where each CB in the first set of CBs is divided into two or more segments, the two or more segments including at least a first segment mapped to a first layer or layer group in a first time-frequency resource and a second segment mapped to a second layer or layer group in a second time-frequency resource in accordance with the MIMO configuration. The apparatus may include means for transmitting a second set of CBs associated with a second transport block encoded in accordance with the MIMO configuration.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram of an example receiver configured to operate in accordance with a multiple-input multiple-output (MIMO) configuration.

FIG. 3 is a diagram illustrating an example associated with demapping and decoding code blocks (CBs) in accordance with a MIMO configuration.

FIG. 4 is a diagram illustrating an example associated with demapping and decoding CBs in accordance with a MIMO configuration.

FIG. 5 is a diagram illustrating an example process performed, for example, at a user equipment (UE) or an apparatus of a UE.

FIG. 6 is a diagram illustrating an example process performed, for example, at a network node or an apparatus of a network node.

FIGS. 7 and 8 are diagrams of example apparatuses for wireless communication.

### DETAILED DESCRIPTION

In wireless communications, particularly multiple-input multiple-output (MIMO) systems communications, efficient signal processing and mapping techniques improve the utilization of available spectral resources and hardware capabilities. Historically, different approaches have been adopted for code word (CW) structures, such as dual CW MIMO designs in Long-Term Evolution (LTE)-based systems where two layers have distinct CWs, and single CW designs with irregular low-density parity-check (LDPC) in New Radio (NR) requiring iterative demodulation and decoding for enhanced performance.

Spatially coupled MIMO (SC-MIMO) systems present yet another evolution in signal processing, wherein a single CW design with spatial coupling is implemented. These systems aim to match the collective channel quality across multiple layers, with code structures designed to capture more channel realizations. In such configurations, successive interference cancellation (SIC) can be used for demapping code blocks (CBs), where each CB is demodulated and decoded sequentially and, upon successful decoding, subtracted from the received signal.

However, the implementation of SC-MIMO systems introduces several technical challenges. For example, the necessity to wait for the re-encoding and SIC before decoding the next CB can lead to lower hardware utilization, resulting in inefficiencies. Additionally, the requirement to buffer part of the last CB until the end of the decoding process, which might span multiple orthogonal frequency-division multiplexing (OFDM) symbols, further complicates the system. Moreover, traditional pipelining schemes employed in SC-MIMO systems can suffer from hardware underutilization due to idle periods, colloquially referred to as “bubbles,” where pieces of hardware are not actively processing signals. This is often due to the need for certain stages of the pipeline to wait for others to complete their tasks, such as waiting for SIC processes to finish before subsequent demapping can occur. Another issue arises with the treatment of head and tail CBs in SC-MIMO systems. For example, in legacy SC-MIMO communication systems, head CBs and tail CBs are mapped to only a subset of layers, which can lead to performance losses in scenarios with high layer imbalance, such as near-perfect singular value decomposition (SVD) conditions.

Various aspects relate generally to a CB-to-layer mapping technique for MIMO configurations in wireless communication systems. Some aspects more specifically relate to transmitting a transport block segmented into a set of CBs, where each CB is divided into multiple segments, with distinct segments mapped to different layers or layer groups across non-consecutive time-frequency resources. In some aspects, the CB-to-layer mapping ensures that each CB spans all layers, with a special CB and a final CB each having segments that are mapped to adjacent time-frequency resources. The CB-to-layer mapping technique can be extended to configurations with more than two layers by, for example, applying the technique to layer groups rather than to individual layers.

Particular aspects of the subject matter described in this disclosure can be implemented to realize one or more of the following potential technical advantages. For example, the described techniques can optimize the efficiency of pipeline processing in SC-MIMO systems, reducing hardware idle times known as “bubbles” and improving hardware utilization. The CB-to-layer mapping technique disclosed herein may enhance robustness against layer imbalance, which is particularly advantageous in near-perfect SVD conditions where traditional mapping techniques may result in performance degradation. In some aspects, the disclosed CB-to-layer mapping techniques may enable continuous operation of hardware components of a receiver, synchronizing each component to eliminate idle periods. Additionally, the CB-to-layer mapping techniques may allow for the use of rules associated with twisting operations, such as cyclic shifts or layer-order inversions, to map CB segments to layers or layer groups.

The disclosed CB-to-layer mapping techniques may further provide technical benefits by decreasing the buffering requirements for the last CB, which can span multiple OFDM symbols. Decreasing the buffering requirements may simplify the system architecture and may lead to more rapid decoding times. Moreover, by ensuring that all CBs, including the special and final CBs, span all layers to avoid consecutive interference, the disclosed CB-to-layer mapping techniques may enhance the efficiency of the demapping and decoding processes. In this way, performing the CB-to-layer mapping techniques may result in conservation of processing resources, memory resources, network resources, or a combination thereof, among other examples, thereby improving spectral efficiency and communication performance. 5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive MIMO, beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

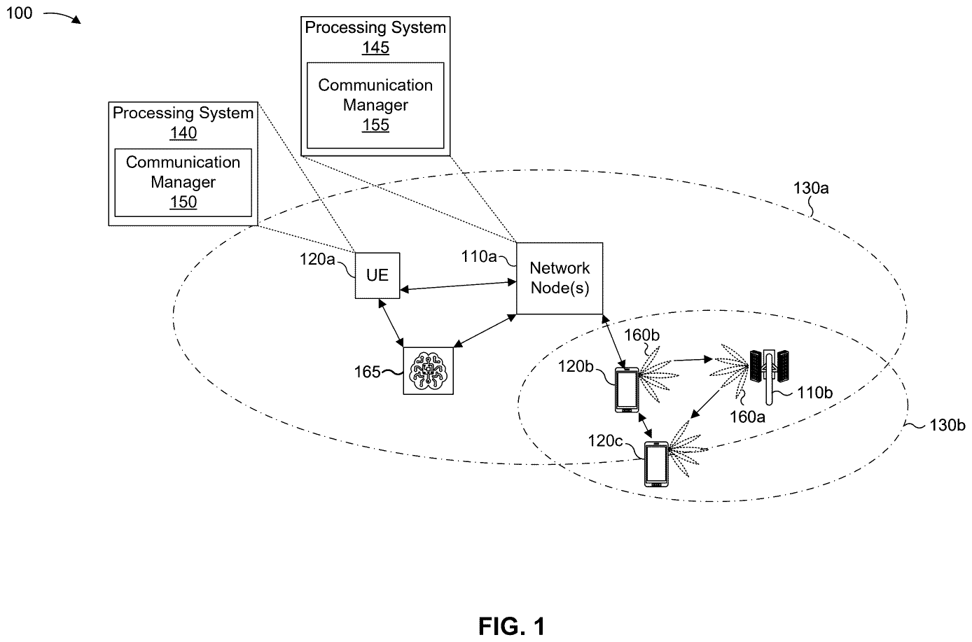

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-OFDM (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, the UE 120 may include a communication manager 150. As described in more detail elsewhere herein, the communication manager 150 may transmit, in accordance with a MIMO configuration, a first transport block segmented into a first set of CBs, wherein each CB in the first set of CBs is divided into two or more segments, the two or more segments including at least a first segment mapped to a first layer or layer group in a first time-frequency resource and a second segment mapped to a second layer or layer group in a second time-frequency resource in accordance with the MIMO configuration; and receive a second set of CBs associated with a second transport block encoded in accordance with the MIMO configuration. Additionally, or alternatively, the communication manager 150 may perform one or more other operations described herein.

In some aspects, the network node 110 may include a communication manager 155. As described in more detail elsewhere herein, the communication manager 155 may receive, in accordance with a multiple-input multiple-output (MIMO) configuration, a first transport block segmented into a first set of code blocks (CBs), wherein each CB in the first set of CBs is divided into two or more segments, the two or more segments including at least a first segment mapped to a first layer or layer group in a first time-frequency resource and a second segment mapped to a second layer or layer group in a second time-frequency resource in accordance with the MIMO configuration; and transmit a second set of CBs associated with a second transport block encoded in accordance with the MIMO configuration. Additionally, or alternatively, the communication manager 155 may perform one or more other operations described herein.

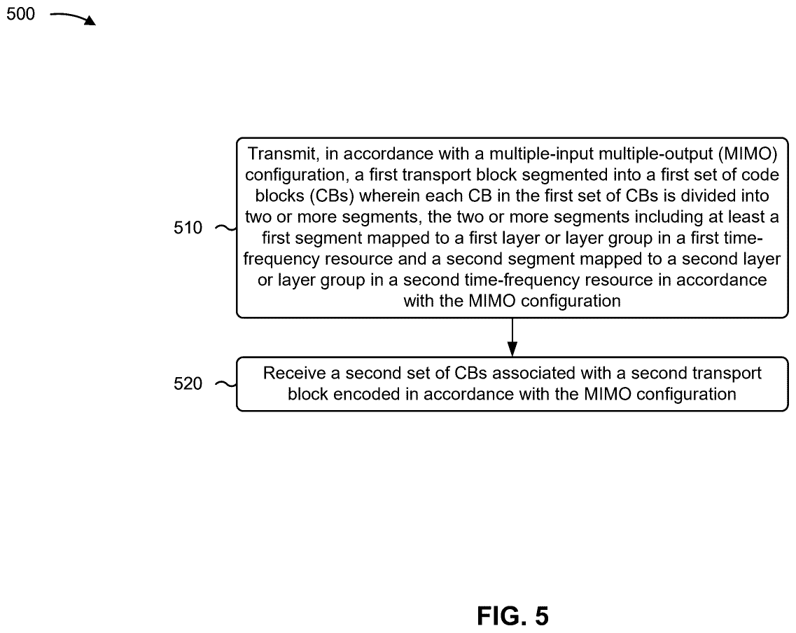

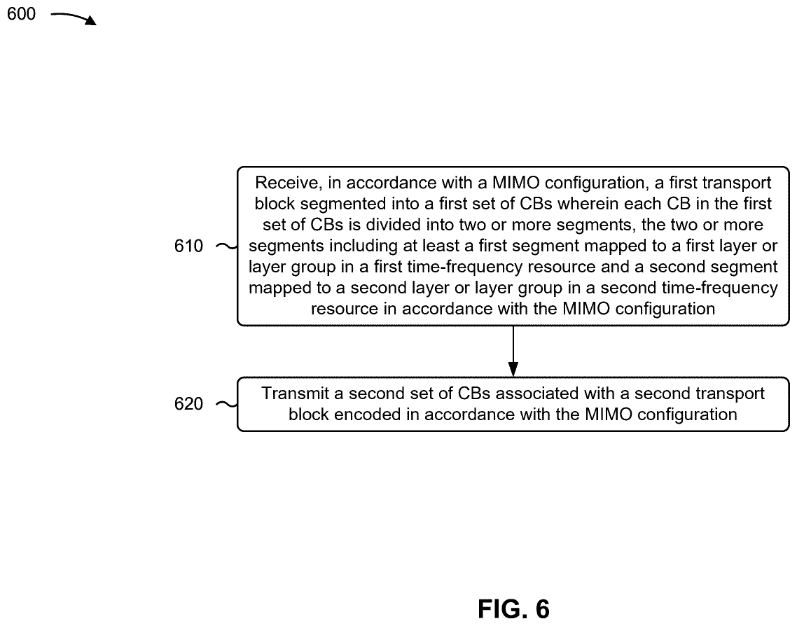

The network node 110, the processing system 145 of the network node 110, the UE 120, the processing system 140 of the UE 120, or any other component(s) of FIG. 1 may implement one or more techniques or perform one or more operations associated with MIMO CB-to-layer mapping, as described in more detail elsewhere herein. For example, the processing system 145 of the network node 110, or the processing system 140 of the UE 120 may perform or direct operations of, for example, process 500 of FIG. 5, process 600 of FIG. 6, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 500 of FIG. 5, process 600 of FIG. 6, or other processes as described herein. In some examples, executing instructions may include running the instructions, converting the instructions, compiling the instructions, or interpreting the instructions, among other examples.

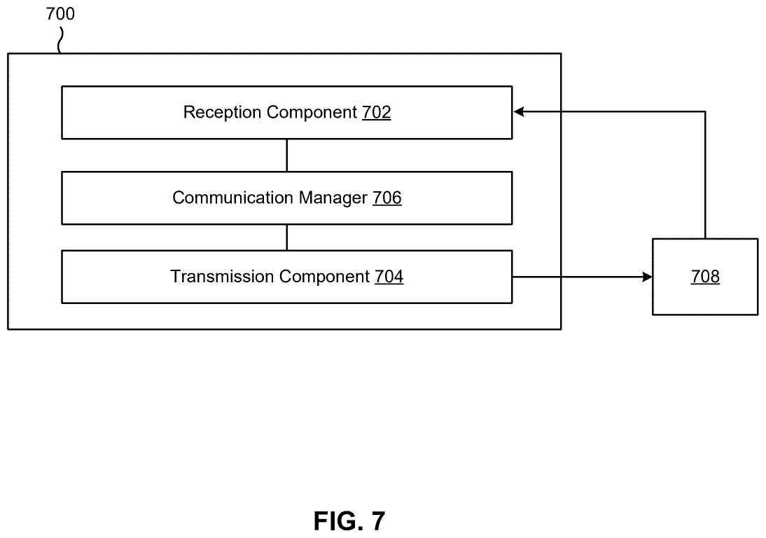

In some aspects, the UE 120 includes means for transmitting, in accordance with a MIMO configuration, a first transport block segmented into a first set of CBs, wherein each CB in the first set of CBs is divided into two or more segments, the two or more segments including at least a first segment mapped to a first layer or layer group in a first time-frequency resource and a second segment mapped to a second layer or layer group in a second time-frequency resource in accordance with the MIMO configuration; or means for receiving a second set of CBs associated with a second transport block encoded in accordance with the MIMO configuration. The means for the UE 120 to perform operations described herein may include, for example, one or more of communication manager 150, processing system 140, a radio, one or more RF chains, one or more transceivers, one or more antennas, one or more modems, a reception component (for example, reception component 702 depicted and described in connection with FIG. 7), or a transmission component (for example, transmission component 704 depicted and described in connection with FIG. 7), among other examples.

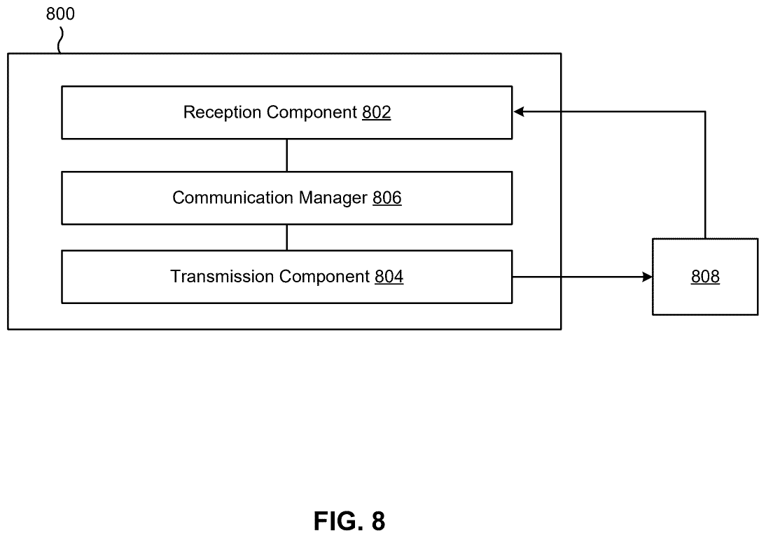

In some aspects, the network node 110 includes means for receiving, in accordance with a MIMO configuration, a first transport block segmented into a first set of CBs, wherein each CB in the first set of CBs is divided into two or more segments, the two or more segments including at least a first segment mapped to a first layer or layer group in a first time-frequency resource and a second segment mapped to a second layer or layer group in a second time-frequency resource in accordance with the MIMO configuration; or means for transmitting a second set of CBs associated with a second transport block encoded in accordance with the MIMO configuration. The means for the network node 110 to perform operations described herein may include, for example, one or more of communication manager 155, processing system 145, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

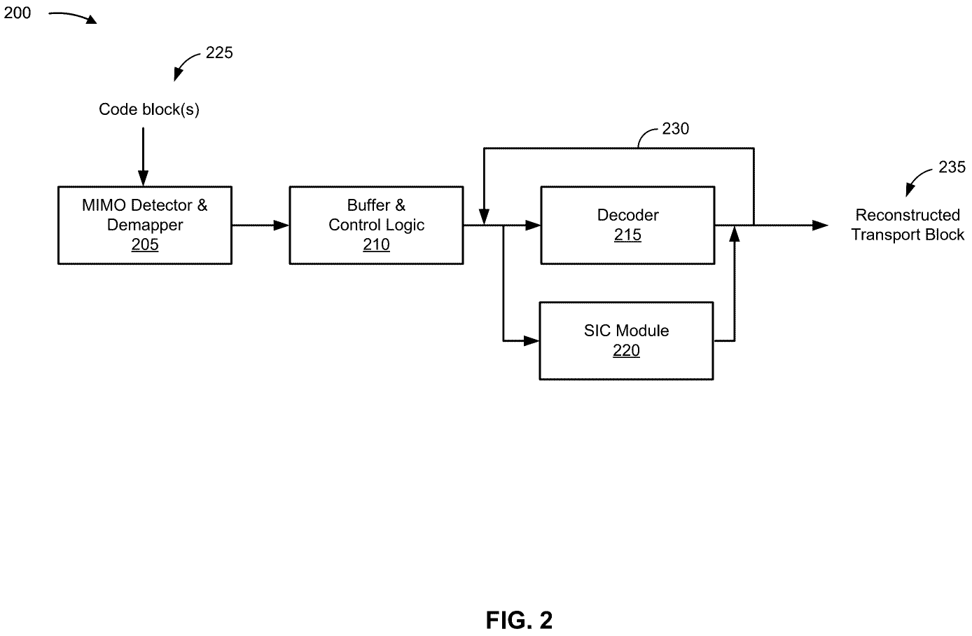

FIG. 2 is a diagram of an example receiver 200 configured to operate in accordance with a MIMO configuration. The receiver 200 includes a MIMO detector and demapper 205, a buffer and control logic module 210, a decoder 215, and an SIC module 220. In some aspects, a UE (e.g., UE 120), a network node 110 (110), or a combination thereof, among other examples, may include the receiver 200 and a transmitter configured to allow the UE or network node to receive and transmit CBs in accordance with the MIMO configuration and a CB-to-layer mapping technique. For example, in some aspects, the receiver 200 may be the reception components 702 or 802 depicted and described in connection with FIG. 7 or 8, respectively.

The MIMO detector and demapper 205 may be configured to receive a set of CBs 225 to facilitate the demapping process. The buffer and control logic module 210 may be configured to manage the flow of data and ensure synchronization between the various components of the receiver 200. The decoder 215 may be configured to decode the CBs 225 and reconstruct a transport block 235. The SIC module 220 may be configured to cancel interference from successively received signals. The feedback signal 230 may provide an output of the SIC module 220 and the decoder 215 to an input of the SIC module 220 and the decoder 215 to allow the decoder 215 and the SIC module 220 to adjust subsequent transmissions and receptions to reduce interference. The reconstructed transport block 235 may be a final output of the receiver 200, and the transport block 235 may be reconstructed in accordance with the MIMO configuration, particularly with respect to a CB-to-layer mapping of the CBs 225.

The receiver 200 may operate by receiving a first transport block segmented into a first set of CBs 225. Each CB in the first set of CBs 225 may be divided into two or more segments, with each segment mapped to different layers or layer groups within non-consecutive time-frequency resources in accordance with the MIMO configuration. Alternatively, a different layer or layer group may be mapped to each of the segments of the CBs 225. Accordingly, the term “CB-to-layer mapping” may refer to mapping the segments of the CBs 225 to layers or mapping the layers to segments of the CBs 225, among other examples. The MIMO configuration may define one or more rules for mapping segments of CBs 225, such as cyclic shifts or layer-order inversions, to optimize the use of time-frequency resources.

In some aspects, such as to transmit the transport block 235 as CBs 225 or segments of CBs 225, a transmitter may generate the transport block 235, encode the transport block 235, segment the transport block 235 into two or more CBs 225, encode a channel via, for example, LDPC encoding, map the two or more CBs 225 to the layers of the MIMO channel in accordance with the MIMO configuration, and transmit the CBs 225.

In some aspects, the transmitter may be the transmission component 704 or 804 depicted and described in connection with FIG. 7 or 8, respectively.

As indicated above, FIG. 2 is provided as an example. Other examples may differ from what is described with regard to FIG. 2.

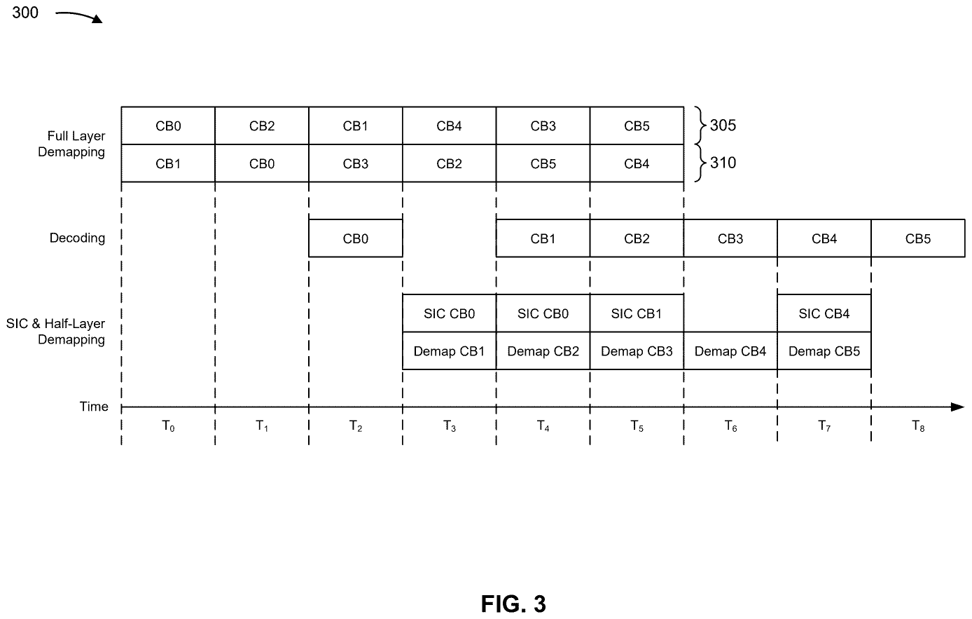

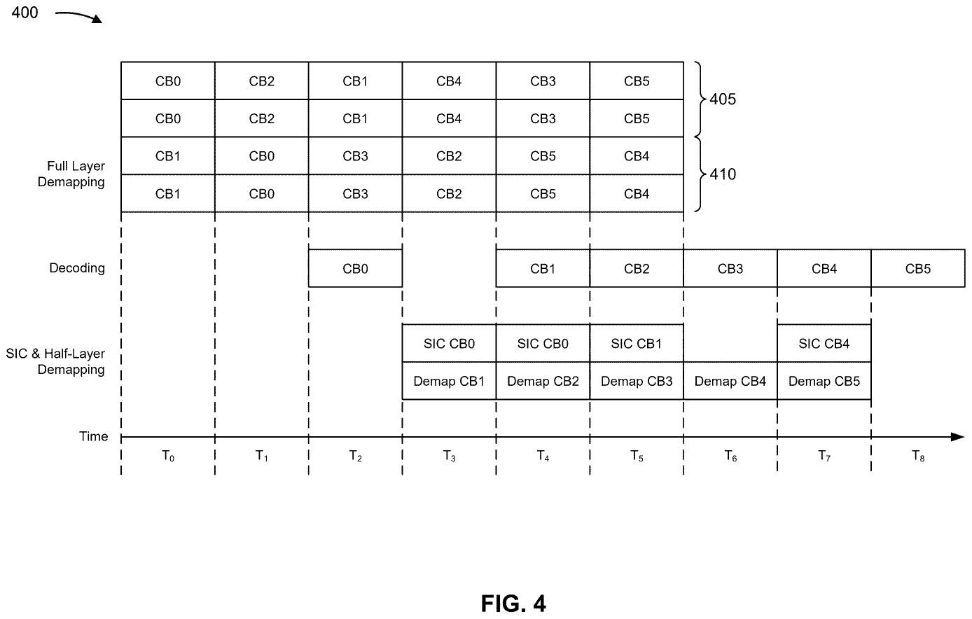

FIG. 3 is a diagram illustrating an example 300 associated with demapping and decoding CBs in accordance with a MIMO configuration. The example 300 includes time instances T₀-T₈ associated with time-frequency resources. In accordance with the MIMO configuration, a transport block may be segmented into a set of CBs such as CB0, CB1, CB2, CB3, CB4, and CB5 shown in the example 300 of FIG. 3. Each CB in the set of CBs may be divided into two or more segments, which may be mapped to layers or layer groups (e.g., a first layer 305 and a second layer 310 in the example 300 of FIG. 3, or a first layer group 405 and a second layer group 410 in the example 400 of FIG. 4) in the time-frequency resources. CB0 may be designated as a special CB, and CB5 may be a final CB in the set of CBs.

The set of CBs may be transmitted in accordance with the MIMO configuration, which may include a CB-to-layer mapping. In some aspects, the CB-to-layer mapping may be generated by a UE (e.g., UE 120) or by a network node (e.g., network node 110). In some aspects, the CB-to-layer mapping may map each CB to a time-frequency resource in a first layer 305 and a time-frequency resource in a second layer 310. For example, as shown in the example 300, segments of the special CB (e.g., CB0) may be mapped to the first layer 305 in a first time-frequency resource T₀ and to the second layer 310 in a second time-frequency resource T₁. Additionally, as shown in the example 300, segments of the final CB (e.g., CB5) may be mapped to the second layer 310 in a fifth time-frequency resource T₄ and to the first layer 305 in a sixth time-frequency resource T₅. In some aspects, segments of the special CB, the final CB, or both, may be mapped to each layer. Accordingly, the special CB, the final CB, or both, may be divided into a quantity of segments equal to a quantity of layers configured via the MIMO configuration. Dividing the special CB and final CB into the quantity of segments equal to the quantity of layers, and mapping each segment of the special CB or the final CB to a different one of the layers, may optimize hardware utilization and provide robustness to layer imbalance.

In some aspects, the segments of the special CB may be mapped to adjacent time-frequency resources, and the segments of the final CB may be mapped to adjacent time-frequency resources. Adjacent time-frequency resources are two time-frequency resources that occur sequentially and without any intervening time-frequency resources between the two time-frequency resources. For example, the segments of the special CB (CB0 in the first layer 305 and CB0 in the second layer 310) may be mapped to the first time-frequency resource T₀ and the second time-frequency resource T₁, respectively, which are adjacent time-frequency resources. The segments of the final

CB (CB5 in the first layer 305 and CB5 in the second layer 310) may be mapped to the fifth time-frequency resource T₄ and the sixth time-frequency resource T₅, respectively, which are adjacent time-frequency resources.

Segments of other CBs (e.g., the segments of the CBs that are not segments of the special CB or segments of the final CB) may be mapped to different layers in non-consecutive time-frequency resources. Accordingly, segments of a CB may be mapped to time-frequency resources with at least one intervening time-frequency resource therebetween. For example, as shown in the example 300 of FIG. 3, segments of a first CB (e.g., CB1) may be mapped to the second layer 310 in the first time-frequency resource T₀ and to the first layer 305 in a third time-frequency resource T₂. The second time-frequency resource T₁ occurs between the first time-frequency resource T₀ and the third time-frequency resource T₂, which makes the first time-frequency resource T₀ and the third time-frequency resource T₂ non-consecutive relative to one another. Additionally, as shown in the example 300 of FIG. 3, segments of each CB are mapped to each layer 305, 310. In some aspects, the segments of the CBs may be mapped in accordance with a cyclic shift operation or a layer-order inversion operation. In some aspects, the mapping of the segments of the CB may be performed in accordance with a rank defined by the quantity of layers, which may improve efficiency and systematic allocation of segments of the CBs to the MIMO layers 305, 310.

In some aspects, the mapping of regular CBs (e.g., CB1, CB2, CB3, and CB4) follows a “twisting” pattern in which segments of a CB appear on alternating layers in different time-frequency resources. For example, a transmitter may map the first CB CB1 to the second layer 310 in the first time-frequency resource T₀ and consecutively apply the twisting pattern to map the next CB (e.g., CB2) to the first layer 305 and to the second layer 310 in a “twisting operation.” The segments of the second CB CB2 occupy the second time-frequency resource T₁ and the fourth time-frequency resource T₃, which are in time-frequency resources following the time-frequency resources (T₀ and T₂) of the segments of the first CB CB1, respectively. In accordance with the twisting pattern, the segments of the second CB CB2 are each mapped to one of the layers in an opposite order than the respective segments of the first CB CB1. For example, in a first iteration of the twisting operation, a first segment of the first CB CB1 is mapped to the second layer 310 in the first time-frequency resource T₀ and a first segment of the second CB CB2 is mapped to the first layer 305 in the second time-frequency resource T₁. In accordance with the twisting pattern, a second segment of the first CB CB1 is mapped to the first layer 305 in the third time-frequency resource T₂ and a second segment of the second CB CB2 is mapped to the second layer 310 in the fourth time-frequency resource T₃. Following the twisting pattern, the third CB CB3 occupies the first layer 305 in the third time-frequency resource T₂ and the second layer 310 in the fifth time-frequency resource T₄. Accordingly, in a second iteration of the twisting operation, the segments of the third CB CB3 are mapped to time-frequency resources following the segments of the second CB CB2, respectively, and on different layers than the preceding segment of the second CB CB2. Likewise, in a third iteration of the twisting operation, the segments of the fourth CB CB4 are mapped to time-frequency resources following the segments of the third CB CB3, respectively, and on different layers than the preceding segment of the third CB CB3.

In some aspects, the UE or network node, or both, may transmit a set of CBs in accordance with the CB-to-layer mapping. For example, in some aspects, a UE may transmit, and a network node may receive, a first set of CBs generated in accordance with the MIMO configuration, including the CB-to-layer mapping discussed above. Alternatively or in addition, in some aspects, the network node may transmit, and the UE may receive, a second set of CBs generated in accordance with the MIMO configuration, including the CB-to-layer mapping discussed above.

Upon receipt of a set of CBs, including the segments of each CB, the UE or network node may be configured to perform a demapping operation on the set of CBs using, for example, a MIMO detector and demapper (e.g., a MIMO detector and demapper 205 discussed above with respect to FIG. 2). One or more of the segments of the CBs may be stored in a buffer until the UE or network node is ready to perform an SIC operation and decode the CB. As shown in FIG. 3, a UE or network node may receive segments of the special CB CB0 on the first layer 305 in the first time-frequency resource T₀ and on the second layer 310 in the second time-frequency resource T₁. The UE or network node may also receive a segment of the first CB CB1 on the second layer 310 in the first time-frequency resource T₀ and a segment of a second CB CB2 on the first layer 305 in the second time-frequency resource T₁. In the third time-frequency resource T₂, the UE or network node may receive the first CB CB1 on a first layer 305 and a third CB CB3 on the second layer 310 and decode the special CB using the previously-received segments of the special CB. In some aspects, the UE or network node may decode the special CB using a lower code rate. In a fourth time-frequency resource T₃, the UE or network node may receive a fourth CB CB4 on a first layer 305 and a second CB CB2 on the second layer 310 and perform an SIC operation to cancel interference associated with the special CB CB0 while demapping the first CB CB1. In the fifth time-frequency resource T₄, the UE or network node may receive the third CB CB3 on a first layer 305 and the final CB CB5 on the second layer 310 and perform an SIC operation to cancel interference associated with the special CB CB0 while demapping the second CB CB2. Also, in the fifth time-frequency resource T₄, the UE or network node may decode the first CB CB1. In the sixth time-frequency resource T₅, the UE or network node may receive the final CB CB5 on the first layer 305 and the fourth CB CB4 on the second layer 310 and perform an SIC operation to cancel interference associated with the first CB CB1 while demapping the third CB CB3. Also, in the sixth time-frequency resource T₅, the UE or network node may decode the second CB CB2. In a seventh time-frequency resource T₆, the UE or network node may perform an SIC operation to cancel interference associated with the second CB CB2 while demapping the fourth CB CB4. Also, in the seventh time-frequency resource T₆, the UE or network node may decode the third CB CB3. In an eighth time-frequency resource T₇, the UE or network node may perform an SIC operation to cancel interference associated with the third CB CB3 while demapping the final CB CB5. Also, in the eighth time-frequency resource T₇, the UE or network node may decode the fourth CB CB4. In a ninth time-frequency resource T₈, the UE or network node may decode the final CB CB5. When the CBs are decoded, the UE or network node may reconstruct the transport block. By applying the MIMO configuration with the CB-to-layer mapping discussed above, the UE, the network node, or both, may reduce idle time at the receiver, mitigate hardware underutilization, and improve communication efficiency in MIMO systems.

As indicated above, FIG. 3 is provided as an example. Other examples may differ from what is described with regard to FIG. 3.

FIG. 4 is a diagram illustrating an example 400 associated with demapping and decoding CBs in accordance with a MIMO configuration. The example 400 includes time instances T₀-T₈ associated with time-frequency resources. In accordance with the MIMO configuration, a transport block may be segmented into a set of CBs, such as CB0, CB1, CB2, CB3, CB4, and CB5 shown in the example 400 of FIG. 4. Each CB in the set of CBs may be divided into two or more segments, which may be mapped to layer groups 405, 410 in the time-frequency resources. Each layer group 405, 410 shown in the example 400 of FIG. 4 includes two layers (e.g., a first layer and a second layer). Additionally, in the example 400 of FIG. 4, CB0 may be designated as a special CB, and CB5 may be a final CB in the set of CBs.

The set of CBs may be transmitted in accordance with the MIMO configuration, which may include a CB-to-layer mapping. In some aspects, the CB-to-layer mapping may be generated by a UE (e.g., UE 120) or by a network node (e.g., network node 110). In some aspects, the CB-to-layer mapping may map each CB to a time-frequency resource in a first layer group 405 and a time-frequency resource in a second layer group 410. For example, as shown in the example 400, segments of the special CB (e.g., CB0) may be mapped to the first layer group 405 in a first time-frequency resource T₀ and to the second layer group 410 in a second time-frequency resource T₁. Additionally, as shown in the example 400, segments of the final CB (e.g., CB5) may be mapped to the second layer group 410 in a fifth time-frequency resource T₄ and to the first layer group 405 in a sixth time-frequency resource T₅. In some aspects, segments of the special CB, the final CB, or both, may be mapped to each layer. Accordingly, the special CB, the final CB, or both, may be divided into a quantity of segments equal to a quantity of layers configured via the MIMO configuration. Dividing the special CB and final CB into the quantity of segments equal to the quantity of layers, and mapping each segment of the special CB or the final CB to a different one of the layers, may optimize hardware utilization and provide robustness to layer imbalance.

In some aspects, the segments of the special CB may be mapped to adjacent time-frequency resources, and the segments of the final CB may be mapped to adjacent time-frequency resources. Adjacent time-frequency resources are two time-frequency resources that occur sequentially and without any intervening time-frequency resources between the two time-frequency resources. For example, the segments of the special CB (CB0 in the first layer group 405 and CB0 in the second layer group 410) may be mapped to the first time-frequency resource T₀ and the second time-frequency resource T₁, respectively, which are adjacent time-frequency resources. The segments of the final CB (CB5 in the first layer group 405 and CB5 in the second layer group 410) may be mapped to the fifth time-frequency resource T₄ and the sixth time-frequency resource T₅, respectively, which are adjacent time-frequency resources.

Other segments of CBs (e.g., the segments of the CBs that are not segments of the special CB or segments of the final CB) may be mapped to different layers in non-consecutive time-frequency resources. Accordingly, segments of a CB may be mapped to time-frequency resources with at least one intervening time-frequency resource therebetween. For example, as shown in the example 400 of FIG. 4, segments of a first CB (e.g., CB1) may be mapped to the second layer group 410 in the first time-frequency resource T₀ and to the first layer group 405 in a third time-frequency resource T₂. The second time-frequency resource T₁ occurs between the first time-frequency resource T₀ and the third time-frequency resource T₂, which makes the first time-frequency resource T₀ and the third time-frequency resource T₂ non-consecutive relative to one another. Additionally, as shown in the example 400 of FIG. 4, segments of each CB are mapped to each layer group 405, 410. In some aspects, the segments of the CBs may be mapped in accordance with a cyclic shift operation or a layer-order inversion operation. In some aspects, the mapping of the segments of the CB may be performed in accordance with a rank defined by the quantity of layers, which may improve efficiency and systematic allocation of segments of the CBs to the MIMO layers 405, 410.

In some aspects, the UE or network node, or both, may transmit a set of CBs in accordance with the CB-to-layer mapping. For example, in some aspects, a UE may transmit, and a network node may receive, a first set of CBs generated in accordance with the MIMO configuration, including the CB-to-layer mapping discussed above. Alternatively or in addition, in some aspects, the network node may transmit, and the UE may receive, a second set of CBs generated in accordance with the MIMO configuration, including the CB-to-layer mapping discussed above.

Upon receipt of a set of CBs, including the segments of each CB, the UE or network node may be configured to perform a demapping operation on the set of CBs using, for example, a MIMO detector and demapper (e.g., a MIMO detector and demapper 205 discussed above with respect to FIG. 2). One or more of the segments of the CBs may be stored in a buffer until the UE or network node is ready to perform an SIC operation and decode the CB. As shown in FIG. 4, a UE or network node may receive segments of the special CB CB0 on the first layer group 405 in the first time-frequency resource T₀ and on layers in the second layer group 410 in the second time-frequency resource T₁. The UE or network node may also receive a segment of the first CB CB1 on layers in the second layer group 410 in the first time-frequency resource T₀ and a segment of a second CB CB2 on the first layer group 405 in the second time-frequency resource T₁. In the third time-frequency resource T₂, the UE or network node may receive the first CB CB1 in layers on a first layer group 405 and a third CB CB3 on layers in the second layer group 410 and decode the special CB using the previously-received segments of the special CB. In some aspects, the UE or network node may decode the special CB using a lower code rate. In a fourth time-frequency resource T₃, the UE or network node may receive a fourth CB CB4 on layers in a first layer group 405 and a second CB CB2 on layers in the second layer group 410 and perform an SIC operation to cancel interference associated with the special CB CB0 while demapping the first CB CB1. In the fifth time-frequency resource T₄, the UE or network node may receive the third CB CB3 on layers in a first layer group 405 and the final CB CB5 on layers in the second layer group 410 and perform an SIC operation to cancel interference associated with the special CB CB0 while demapping the second CB CB2. Also, in the fifth time-frequency resource T₄, the UE or network node may decode the first CB CB1. In the sixth time-frequency resource T₅, the UE or network node may receive the final CB CB5 on the first layer group 405 and the fourth CB CB4 on layers in the second layer group 410 and perform an SIC operation to cancel interference associated with the first CB CB1 while demapping the third CB CB3. Also, in the sixth time-frequency resource T₅, the UE or network node may decode the second CB CB2. In a seventh time-frequency resource T₆, the UE or network node may perform an SIC operation to cancel interference associated with the second CB CB2 while demapping the fourth CB CB4. Also, in the seventh time-frequency resource T₆, the UE or network node may decode the third CB CB3. In an eighth time-frequency resource T₇, the UE or network node may perform an SIC operation to cancel interference associated with the third CB CB3 while demapping the final CB CB5. Also, in the eighth time-frequency resource T₇, the UE or network node may decode the fourth CB CB4. In a ninth time-frequency resource T₈, the UE or network node may decode the final CB CB5. When the CBs are decoded, the UE or network node may reconstruct the transport block. By applying the MIMO configuration with the CB-to-layer mapping discussed above, the UE, the network node, or both, may reduce idle time at the receiver, mitigate hardware underutilization, and improve communication efficiency in MIMO systems.

As indicated above, FIG. 4 is provided as an example. Other examples may differ from what is described with regard to FIG. 4.

FIG. 5 is a diagram illustrating an example process 500 performed, for example, at a UE or an apparatus of a UE. Example process 500 is an example where the apparatus or the UE (e.g., UE 120) performs operations associated with MIMO CB-to-layer mapping.

As shown in FIG. 5, in some aspects, process 500 may include transmitting, in accordance with a MIMO configuration, a first transport block segmented into a first set of CBs, wherein each CB in the first set of CBs is divided into two or more segments, the two or more segments including at least a first segment mapped to a first layer or layer group in a first time-frequency resource and a second segment mapped to a second layer or layer group in a second time-frequency resource in accordance with the MIMO configuration (block 510). For example, the UE (e.g., using transmission component 704 or communication manager 706, depicted in FIG. 7) may transmit, in accordance with a MIMO configuration, a first transport block segmented into a first set of CBs, wherein each CB in the first set of CBs is divided into two or more segments, the two or more segments including at least a first segment mapped to a first layer or layer group in a first time-frequency resource and a second segment mapped to a second layer or layer group in a second time-frequency resource in accordance with the MIMO configuration, as described above in connection with FIGS. 2-4. In some aspects, each CB in the first set of CBs is divided into two or more segments, the two or more segments including at least a first segment mapped to a first layer or layer group in a first time-frequency resource and a second segment mapped to a second layer or layer group in a second time-frequency resource in accordance with the MIMO configuration.

As further shown in FIG. 5, in some aspects, process 500 may include receiving a second set of CBs associated with a second transport block encoded in accordance with the MIMO configuration (block 520). For example, the UE (e.g., using reception component 702 or communication manager 706, depicted in FIG. 7) may receive a second set of CBs associated with a second transport block encoded in accordance with the MIMO configuration, as described above in connection with FIGS. 2-4.

Process 500 may include additional aspects, such as any single aspect or any combination of aspects described below or in connection with one or more other processes described elsewhere herein.

In a first aspect, the first time-frequency resource and the second time-frequency resource are non-consecutive resources.

In a second aspect, alone or in combination with the first aspect, each CB in the first set of CBs includes at least one segment in each layer or layer group.

In a third aspect, alone or in combination with one or more of the first and second aspects, the first set of CBs includes a special CB divided into two or more segments, and the two or more segments of the special CB are mapped to different layers or layer groups of adjacent time-frequency resources.

In a fourth aspect, alone or in combination with one or more of the first through third aspects, the first set of CBs includes a special CB divided into a quantity of segments equal to a quantity of layers or layer groups configured by the MIMO configuration.

In a fifth aspect, alone or in combination with one or more of the first through fourth aspects, the first set of CBs includes a special CB divided into two or more segments, and each of the first layer or layer group and the second layer or layer group are mapped to at least one segment of the special CB.

In a sixth aspect, alone or in combination with one or more of the first through fifth aspects, the first set of CBs includes a final CB divided into two or more segments, and each segment of the final CB is mapped to different layers or layer groups of adjacent time-frequency resources.

In a seventh aspect, alone or in combination with one or more of the first through sixth aspects, process 500 includes encoding the first transport block in accordance with the MIMO configuration to generate the first set of CBs.

In an eighth aspect, alone or in combination with one or more of the first through seventh aspects, process 500 includes decoding the second set of CBs in accordance with the MIMO configuration, and reconstructing the second transport block.

In a ninth aspect, alone or in combination with one or more of the first through eighth aspects, the MIMO configuration includes one or more rules associated with mapping the first segment of each CB of the first set of CBs to the first layer or layer group.

In a tenth aspect, alone or in combination with one or more of the first through ninth aspects, the MIMO configuration includes one or more rules associated with mapping the second segment of each CB of the first set of CBs to the second layer or layer group.

In an eleventh aspect, alone or in combination with one or more of the first through tenth aspects, the MIMO configuration includes one or more rules associated with mapping the first layer or layer group to the first segment of each CB of the first set of CBs.

In a twelfth aspect, alone or in combination with one or more of the first through eleventh aspects, the MIMO configuration includes one or more rules associated with mapping the second layer or layer group to the second segment of each CB of the first set of CBs.

In a thirteenth aspect, alone or in combination with one or more of the first through twelfth aspects, the MIMO configuration includes one or more rules associated with performing a cyclic shift or layer-order inversion to map the first segment of each CB of the first set of CBs to the first layer or layer group and to map the second segment of each CB of the first set of CBs to the second layer or layer group.

In a fourteenth aspect, alone or in combination with one or more of the first through thirteenth aspects, the MIMO configuration includes one or more rules associated with mapping the first segment of each CB of the first set of CBs to the first layer or layer group and mapping the second segment of each CB of the first set of CBs to the second layer or layer group in accordance with a rank defined by a quantity of layers.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, at a network node or an apparatus of a network node. Example process 600 is an example where the apparatus or the network node (e.g., network node 110) performs operations associated with MIMO CB-to-layer mapping.

As shown in FIG. 6, in some aspects, process 600 may include receiving, in accordance with a MIMO configuration, a first transport block segmented into a first set of CBs, wherein each CB in the first set of CBs is divided into two or more segments, the two or more segments including at least a first segment mapped to a first layer or layer group in a first time-frequency resource and a second segment mapped to a second layer or layer group in a second time-frequency resource in accordance with the MIMO configuration (block 610). For example, the network node (e.g., using reception component 802 or communication manager 806, depicted in FIG. 8) may receive, in accordance with a MIMO configuration, a first transport block segmented into a first set of CBs, wherein each CB in the first set of CBs is divided into two or more segments, the two or more segments including at least a first segment mapped to a first layer or layer group in a first time-frequency resource and a second segment mapped to a second layer or layer group in a second time-frequency resource in accordance with the MIMO configuration, as described above in connection with FIGS. 2-4. In some aspects, each CB in the first set of CBs is divided into two or more segments, the two or more segments including at least a first segment mapped to a first layer or layer group in a first time-frequency resource and a second segment mapped to a second layer or layer group in a second time-frequency resource in accordance with the MIMO configuration.

As further shown in FIG. 6, in some aspects, process 600 may include transmitting a second set of CBs associated with a second transport block encoded in accordance with the MIMO configuration (block 620). For example, the network node (e.g., using transmission component 804 or communication manager 806, depicted in FIG. 8) may transmit a second set of CBs associated with a second transport block encoded in accordance with the MIMO configuration, as described above in connection with FIGS. 2-4.

Process 600 may include additional aspects, such as any single aspect or any combination of aspects described below or in connection with one or more other processes described elsewhere herein.

In a first aspect, the first time-frequency resource and the second time-frequency resource are non-consecutive resources.

In a second aspect, alone or in combination with the first aspect, each CB in the first set of CBs includes at least one segment in each layer or layer group.

In a third aspect, alone or in combination with one or more of the first and second aspects, the first set of CBs includes a special CB divided into two or more segments, and the two or more segments of the special CB are mapped to different layers or layer groups of adjacent time-frequency resources.

In a fourth aspect, alone or in combination with one or more of the first through third aspects, the first set of CBs includes a special CB divided into a quantity of segments equal to a quantity of layers or layer groups configured by the MIMO configuration.

In a fifth aspect, alone or in combination with one or more of the first through fourth aspects, the first set of CBs includes a special CB divided into two or more segments, and each of the first layer or layer group and the second layer or layer group are mapped to at least one segment of the special CB.

In a sixth aspect, alone or in combination with one or more of the first through fifth aspects, the first set of CBs includes a final CB divided into two or more segments, and each segment of the final CB is mapped to different layers or layer groups of adjacent time-frequency resources.

In a seventh aspect, alone or in combination with one or more of the first through sixth aspects, process 600 includes encoding the first transport block in accordance with the MIMO configuration to generate the second set of CBs.

In an eighth aspect, alone or in combination with one or more of the first through seventh aspects, process 600 includes decoding the first set of CBs in accordance with the MIMO configuration, and reconstructing the first transport block.

In a ninth aspect, alone or in combination with one or more of the first through eighth aspects, the MIMO configuration includes one or more rules associated with mapping the first segment of each CB of the first set of CBs to the first layer or layer group.

In a tenth aspect, alone or in combination with one or more of the first through ninth aspects, the MIMO configuration includes one or more rules associated with mapping the second segment of each CB of the first set of CBs to the second layer or layer group.

In an eleventh aspect, alone or in combination with one or more of the first through tenth aspects, the MIMO configuration includes one or more rules associated with mapping the first layer or layer group to the first segment of each CB of the first set of CBs.

In a twelfth aspect, alone or in combination with one or more of the first through eleventh aspects, the MIMO configuration includes one or more rules associated with mapping the second layer or layer group to the second segment of each CB of the first set of CBs.

In a thirteenth aspect, alone or in combination with one or more of the first through twelfth aspects, the MIMO configuration includes one or more rules associated with performing a cyclic shift or layer-order inversion to map the first segment of each CB of the first set of CBs to the first layer or layer group and to map the second segment of each CB of the first set of CBs to the second layer or layer group.

In a fourteenth aspect, alone or in combination with one or more of the first through thirteenth aspects, the MIMO configuration includes one or more rules associated with mapping the first segment of each CB of the first set of CBs to the first layer or layer group and mapping the second segment of each CB of the first set of CBs to the second layer or layer group in accordance with a rank defined by a quantity of layers.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE, or a UE may include the apparatus 700. In some aspects, the apparatus 700 includes a reception component 702, a transmission component 704, or a communication manager 706, which may be in communication with one another (for example, via one or more buses or one or more other components). In some aspects, the communication manager 706 is the communication manager 150 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 140 described in connection with FIG. 1) of the UE.

In some aspects, the apparatus 700 may be configured to perform one or more operations described herein in connection with FIGS. 2-4. Additionally, or alternatively, the apparatus 700 may be configured to perform one or more processes described herein, such as process 500 of FIG. 5. In some aspects, the apparatus 700 or one or more components shown in FIG. 7 may include one or more components of the UE described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the UE described above in connection with FIG. 1, such as a radio, one or more RF chains, one or more transceivers, or one or more modems, each of which may in turn be coupled with one or more antennas of the UE.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 704 may be co-located with the reception component 702.

The communication manager 706 may support operations of the reception component 702 or the transmission component 704. For example, the communication manager 706 may receive information associated with configuring reception of communications by the reception component 702 or transmission of communications by the transmission component 704. Additionally, or alternatively, the communication manager 706 may generate or provide control information to the reception component 702 or the transmission component 704 to control reception or transmission of communications.

The transmission component 704 may transmit, in accordance with a MIMO configuration, a first transport block segmented into a first set of CBs, wherein each CB in the first set of CBs is divided into two or more segments, the two or more segments including at least a first segment mapped to a first layer or layer group in a first time-frequency resource and a second segment mapped to a second layer or layer group in a second time-frequency resource in accordance with the MIMO configuration. The reception component 702 may receive a second set of CBs associated with a second transport block encoded in accordance with the MIMO configuration.

The communication manager 706 may encode the first transport block in accordance with the MIMO configuration to generate the first set of CBs. The communication manager 706 may decode the second set of CBs in accordance with the MIMO configuration. The communication manager 706 may reconstruct the second transport block.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication. The apparatus 800 may be a network node, or a network node may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 155 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 145 described in connection with FIG. 1) of the network node.

In some aspects, the apparatus 800 may be configured to perform one or more operations described herein in connection with FIGS. 2-4. Additionally, or alternatively, the apparatus 800 may be configured to perform one or more processes described herein, such as process 600 of FIG. 6. In some aspects, the apparatus 800 or one or more components shown in FIG. 8 may include one or more components of the network node described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the network node described above in connection with FIG. 1, such as a radio, one or more RF chains, one or more transceivers, or one or more modems, each of which may in turn be coupled with one or more antennas of the network node. In some aspects, the reception component 802 or the transmission component 804 may include or may be included in a network interface. The network interface may be configured to obtain or output signals for the apparatus 800 via one or more communications links, such as a backhaul link, a midhaul link, or a fronthaul link.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The reception component 802 may receive, in accordance with a MIMO configuration, a first transport block segmented into a first set of CBs, wherein each CB in the first set of CBs is divided into two or more segments, the two or more segments including at least a first segment mapped to a first layer or layer group in a first time-frequency resource and a second segment mapped to a second layer or layer group in a second time-frequency resource in accordance with the MIMO configuration. The transmission component 804 may transmit a second set of CBs associated with a second transport block encoded in accordance with the MIMO configuration. The communication manager 806 may encode the first transport block in accordance with the MIMO configuration to generate the second set of CBs. The communication manager 806 may decode the first set of CBs in accordance with the MIMO configuration. The communication manager 806 may reconstruct the first transport block.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:
Aspect 1: A method of wireless communication performed by a UE, comprising: transmitting, in accordance with a MIMO configuration, a first transport block segmented into a first set of CBs, wherein each CB in the first set of CBs is divided into two or more segments, the two or more segments including at least a first segment mapped to a first layer or layer group in a first time-frequency resource and a second segment mapped to a second layer or layer group in a second time-frequency resource in accordance with the MIMO configuration; and receiving a second set of CBs associated with a second transport block encoded in accordance with the MIMO configuration.
Aspect 2: The method of Aspect 1, wherein the first time-frequency resource and the second time-frequency resource are non-consecutive resources.
Aspect 3: The method of any of Aspects 1-2, wherein each CB in the first set of CBs includes at least one segment in each layer or layer group.
Aspect 4: The method of any of Aspects 1-3, wherein the first set of CBs includes a special CB divided into two or more segments, and wherein the two or more segments of the special CB are mapped to different layers or layer groups of adjacent time-frequency resources.
Aspect 5: The method of any of Aspects 1-4, wherein the first set of CBs includes a special CB divided into a quantity of segments equal to a quantity of layers or layer groups configured by the MIMO configuration.
Aspect 6: The method of any of Aspects 1-5, wherein the first set of CBs includes a special CB divided into two or more segments, and wherein each of the first layer or layer group and the second layer or layer group are mapped to at least one segment of the special CB.
Aspect 7: The method of any of Aspects 1-6, wherein the first set of CBs includes a final CB divided into two or more segments, and wherein each segment of the final CB is mapped to different layers or layer groups of adjacent time-frequency resources.
Aspect 8: The method of any of Aspects 1-7, further comprising encoding the first transport block in accordance with the MIMO configuration to generate the first set of CBs.
Aspect 9: The method of any of Aspects 1-8, further comprising: decoding the second set of CBs in accordance with the MIMO configuration; and reconstructing the second transport block.
Aspect 10: The method of any of Aspects 1-9, wherein the MIMO configuration includes one or more rules associated with mapping the first segment of each CB of the first set of CBs to the first layer or layer group.
Aspect 11: The method of Aspect 10, wherein the MIMO configuration includes one or more rules associated with mapping the second segment of each CB of the first set of CBs to the second layer or layer group.
Aspect 12: The method of any of Aspects 1-11, wherein the MIMO configuration includes one or more rules associated with mapping the first layer or layer group to the first segment of each CB of the first set of CBs.
Aspect 13: The method of Aspect 12, wherein the MIMO configuration includes one or more rules associated with mapping the second layer or layer group to the second segment of each CB of the first set of CBs.
Aspect 14: The method of any of Aspects 1-13, wherein the MIMO configuration includes one or more rules associated with performing a cyclic shift or layer-order inversion to map the first segment of each CB of the first set of CBs to the first layer or layer group and to map the second segment of each CB of the first set of CBs to the second layer or layer group.
Aspect 15: The method of any of Aspects 1-14, wherein the MIMO configuration includes one or more rules associated with mapping the first segment of each CB of the first set of CBs to the first layer or layer group and mapping the second segment of each CB of the first set of CBs to the second layer or layer group in accordance with a rank defined by a quantity of layers.
Aspect 16: A method of wireless communication performed by a network node, comprising: receiving, in accordance with a MIMO configuration, a first transport block segmented into a first set of CBs, wherein each CB in the first set of CBs is divided into two or more segments, the two or more segments including at least a first segment mapped to a first layer or layer group in a first time-frequency resource and a second segment mapped to a second layer or layer group in a second time-frequency resource in accordance with the MIMO configuration; and transmitting a second set of CBs associated with a second transport block encoded in accordance with the MIMO configuration.
Aspect 17: The method of Aspect 16, wherein the first time-frequency resource and the second time-frequency resource are non-consecutive resources.
Aspect 18: The method of any of Aspects 16-17, wherein each CB in the first set of CBs includes at least one segment in each layer or layer group.
Aspect 19: The method of any of Aspects 16-18, wherein the first set of CBs includes a special CB divided into two or more segments, and wherein the two or more segments of the special CB are mapped to different layers or layer groups of adjacent time-frequency resources.
Aspect 20: The method of any of Aspects 16-19, wherein the first set of CBs includes a special CB divided into a quantity of segments equal to a quantity of layers or layer groups configured by the MIMO configuration.
Aspect 21: The method of any of Aspects 16-20, wherein the first set of CBs includes a special CB divided into two or more segments, and wherein each of the first layer or layer group and the second layer or layer group are mapped to at least one segment of the special CB.
Aspect 22: The method of any of Aspects 16-21, wherein the first set of CBs includes a final CB divided into two or more segments, and wherein each segment of the final CB is mapped to different layers or layer groups of adjacent time-frequency resources.
Aspect 23: The method of any of Aspects 16-22, further comprising encoding the first transport block in accordance with the MIMO configuration to generate the second set of CBs.
Aspect 24: The method of any of Aspects 16-23, further comprising: decoding the first set of CBs in accordance with the MIMO configuration; and reconstructing the first transport block.
Aspect 25: The method of any of Aspects 16-24, wherein the MIMO configuration includes one or more rules associated with mapping the first segment of each CB of the first set of CBs to the first layer or layer group.
Aspect 26: The method of Aspect 25, wherein the MIMO configuration includes one or more rules associated with mapping the second segment of each CB of the first set of CBs to the second layer or layer group.
Aspect 27: The method of any of Aspects 16-26, wherein the MIMO configuration includes one or more rules associated with mapping the first layer or layer group to the first segment of each CB of the first set of CBs.
Aspect 28: The method of Aspect 27, wherein the MIMO configuration includes one or more rules associated with mapping the second layer or layer group to the second segment of each CB of the first set of CBs.
Aspect 29: The method of any of Aspects 16-28, wherein the MIMO configuration includes one or more rules associated with performing a cyclic shift or layer-order inversion to map the first segment of each CB of the first set of CBs to the first layer or layer group and to map the second segment of each CB of the first set of CBs to the second layer or layer group.
Aspect 30: The method of any of Aspects 16-29, wherein the MIMO configuration includes one or more rules associated with mapping the first segment of each CB of the first set of CBs to the first layer or layer group and mapping the second segment of each CB of the first set of CBs to the second layer or layer group in accordance with a rank defined by a quantity of layers.
Aspect 31: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-30.
Aspect 32: An apparatus for wireless communication at a device, the apparatus comprising one or more memories and one or more processors coupled to the one or more memories, the one or more processors configured to cause the device to perform the method of one or more of Aspects 1-30.
Aspect 33: An apparatus for wireless communication, the apparatus comprising at least one means for performing the method of one or more of Aspects 1-30.
Aspect 34: A non-transitory computer-readable medium storing code for wireless communication, the code comprising instructions executable by one or more processors to perform the method of one or more of Aspects 1-30.
Aspect 35: A non-transitory computer-readable medium storing a set of instructions for wireless communication, the set of instructions comprising one or more instructions that, when executed by one or more processors of a device, cause the device to perform the method of one or more of Aspects 1-30.
Aspect 36: A device for wireless communication, the device comprising a processing system that includes one or more processors and one or more memories coupled with the one or more processors, the processing system configured to cause the device to perform the method of one or more of Aspects 1-30.
Aspect 37: An apparatus for wireless communication at a device, the apparatus comprising one or more memories and one or more processors coupled to the one or more memories, the one or more processors individually or collectively configured to cause the device to perform the method of one or more of Aspects 1-30.
Aspect 38: A device comprising a processing system that includes one or more processors and one or more code-storing memories coupled with the one or more processors, the processing system configured to cause the device to perform the method of one or more of Aspects 1-30.
Aspect 39: A device comprising a processing system that includes processor circuitry and code-storing memory circuitry, the processing system configured to cause the device to perform the method of one or more of Aspects 1-30.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
transmit, in accordance with a multiple-input multiple-output (MIMO) configuration, a first transport block segmented into a first set of code blocks (CBs),
wherein each CB in the first set of CBs is divided into two or more segments, the two or more segments including at least a first segment mapped to a first layer or layer group in a first time-frequency resource and a second segment mapped to a second layer or layer group in a second time-frequency resource in accordance with the MIMO configuration; and
receive a second set of CBs associated with a second transport block encoded in accordance with the MIMO configuration.

2. The UE of claim 1, wherein the first time-frequency resource and the second time-frequency resource are non-consecutive resources.

3. The UE of claim 1, wherein each CB in the first set of CBs includes at least one segment in each layer or layer group.

4. The UE of claim 1, wherein the first set of CBs includes a special CB divided into two or more segments, and
wherein the two or more segments of the special CB are mapped to different layers or layer groups of adjacent time-frequency resources.

5. The UE of claim 1, wherein the first set of CBs includes a special CB divided into a quantity of segments equal to a quantity of layers or layer groups configured by the MIMO configuration.

6. The UE of claim 1, wherein the first set of CBs includes a special CB divided into two or more segments, and
wherein each of the first layer or layer group and the second layer or layer group are mapped to at least one segment of the special CB.

7. The UE of claim 1, wherein the first set of CBs includes a final CB divided into two or more segments, and wherein each segment of the final CB is mapped to different layers or layer groups of adjacent time-frequency resources.

8. The UE of claim 1, wherein the processing system is configured to cause the UE to encode the first transport block in accordance with the MIMO configuration to generate the first set of CBs.

9. The UE of claim 1, wherein the processing system is configured to cause the UE to:
decode the second set of CBs in accordance with the MIMO configuration; and
reconstruct the second transport block.

10. The UE of claim 1, wherein the MIMO configuration includes one or more rules associated with mapping the first segment of each CB of the first set of CBs to the first layer or layer group.

11. The UE of claim 10, wherein the MIMO configuration includes one or more rules associated with mapping the second segment of each CB of the first set of CBs to the second layer or layer group.

12. The UE of claim 1, wherein the MIMO configuration includes one or more rules associated with mapping the first layer or layer group to the first segment of each CB of the first set of CBs.

13. The UE of claim 12, wherein the MIMO configuration includes one or more rules associated with mapping the second layer or layer group to the second segment of each CB of the first set of CBs.

14. The UE of claim 1, wherein the MIMO configuration includes one or more rules associated with performing a cyclic shift or layer-order inversion to map the first segment of each CB of the first set of CBs to the first layer or layer group and to map the second segment of each CB of the first set of CBs to the second layer or layer group.

15. The UE of claim 1, wherein the MIMO configuration includes one or more rules associated with mapping the first segment of each CB of the first set of CBs to the first layer or layer group and mapping the second segment of each CB of the first set of CBs to the second layer or layer group in accordance with a rank defined by a quantity of layers.

16. A network node, comprising:
a processing system that includes one or more processors and one or more code-storing memories coupled with the one or more processors, the processing system configured to cause the network node to:
receive, in accordance with a multiple-input multiple-output (MIMO) configuration, a first transport block segmented into a first set of code blocks (CBs),
wherein each CB in the first set of CBs is divided into two or more segments, the two or more segments including at least a first segment mapped to a first layer or layer group in a first time-frequency resource and a second segment mapped to a second layer or layer group in a second time-frequency resource in accordance with the MIMO configuration; and
transmit a second set of CBs associated with a second transport block encoded in accordance with the MIMO configuration.

17. The network node of claim 16, wherein the first time-frequency resource and the second time-frequency resource are non-consecutive resources.

18. The network node of claim 16, wherein the first set of CBs includes a special CB divided into two or more segments, and
wherein the two or more segments of the special CB are mapped to different layers or layer groups of adjacent time-frequency resources.

19. The network node of claim 16, wherein the first set of CBs includes a special CB divided into a quantity of segments equal to a quantity of layers or layer groups configured by the MIMO configuration.

20. A method of wireless communication performed by a user equipment (UE), comprising:
transmitting, in accordance with a multiple-input multiple-output (MIMO) configuration, a first transport block segmented into a first set of code blocks (CBs),
wherein each CB in the first set of CBs is divided into two or more segments, the two or more segments including at least a first segment mapped to a first layer or layer group in a first time-frequency resource and a second segment mapped to a second layer or layer group in a second time-frequency resource in accordance with the MIMO configuration; and
receiving a second set of CBs associated with a second transport block encoded in accordance with the MIMO configuration.
